(19) United States
(12) Patent Application Publication
(10) Pub. No.: US 2008/0235514 A1
(43) Pub. Date: Sep. 25, 2008

(54) SAFEGUARDING ROUTER CONFIGURATION DATA

(75) Inventor: Dale S. Walker, Houston, TX (US)

Correspondence Address: CONLEY ROSE, P.C.;David A. Rose, P. O. BOX 3267, HOUSTON, TX, 77253-3267, US

(73) Assignee: ERF WIRELESS, INC., League City, TX (US)

(21) Appl. No.: 11/689,712

(22) Filed: Mar. 22, 2007

(51) Int. Cl. H04L 9/00

(52) U.S. Cl. 713/185

(57) ABSTRACT

Systems for safeguarding router configuration data are described herein. Some illustrative embodiments include a system that includes a network router, a configuration device comprising configuration data used to configure the network router, and a connector capable of detachably coupling the configuration device to the network router and further capable of detachably coupling a second device to the network router (the connector routes electrical power provided by the network router to a coupled device). The electrical power is set to a voltage level usable to operate the configuration device, while capable of rendering the second device inoperative.

### RELATED APPLICATIONS

This application contains subject matter that may be related to U.S. Nonprovisional application Ser. No. 11/533,652, filed Sep. 20, 2006 and entitled “Router for Use in a Monitored Network,” to U.S. Nonprovisional application Ser. No. 11/533,672, filed Sep. 20, 2006 and entitled “Monitoring Server For Monitoring A Network Of Routers,” and to U.S. Nonprovisional application Ser. No. ______, filed ______, 2007 and entitled “Separate Secure Networks Over A Non-Secure Network,” all of which are herein incorporated by reference.

### BACKGROUND

Routers are electrical devices that are used to permit computers and networks of computers to pass information back and forth. A router typically has one or more input ports and one or more output ports. Data packets containing a destination address arrive on an input port. Based on the destination address or other information, the router forwards the data packet to an appropriate output port which may be connected to the destination node or to another router.

The information being transmitted between routers may be confidential (e.g., bank account information in the context of a bank's network) and thus the security of such information should be ensured. Accordingly, at least some routers provide encryption to allow secure communications across an untrusted communication channel, such as the Internet.

Unfortunately, such routers only ensure security of information transmitted between the routers. The security of the routers themselves often is not ensured. For example, a network engineer responsible for the router may be given full control of the router for purposes of maintaining and configuring the router, thereby creating a single point of control problem.

### SUMMARY

Systems for safeguarding router configuration data are described herein. Some illustrative embodiments include a system that includes a network router, a configuration device comprising configuration data used to configure the network router, and a connector capable of detachably coupling the configuration device to the network router and further capable of detachably coupling a second device to the network router (the connector routes electrical power provided by the network router to a coupled device). The electrical power is set to a voltage level usable to operate the configuration device, while capable of rendering the second device inoperative.

Other illustrative embodiments include a system that includes a network router, means for storing data to configure the network router, means for detachably coupling either the means for storing or an electrically incompatible device to the network router, and for routing electrical power from the network router to the means for storing and the electrically incompatible device, and means for generating a voltage that is usable to operate the means for storing while rendering the electrically incompatible device inoperative.

Yet further illustrative embodiments include a system that includes a network router; and a connector capable of detachably coupling each of a plurality of devices to the network router (the connector further capable of routing electrical power provided by the network router to a coupled device). The electrical power is set to a voltage level usable to operate an electrically compatible device of the plurality of devices, while capable of rendering an electrically incompatible device of the plurality of devices inoperative.

### BRIEF DESCRIPTION

For a detailed description of the illustrative embodiments of the invention, reference will now be made to the accompanying drawings in which:

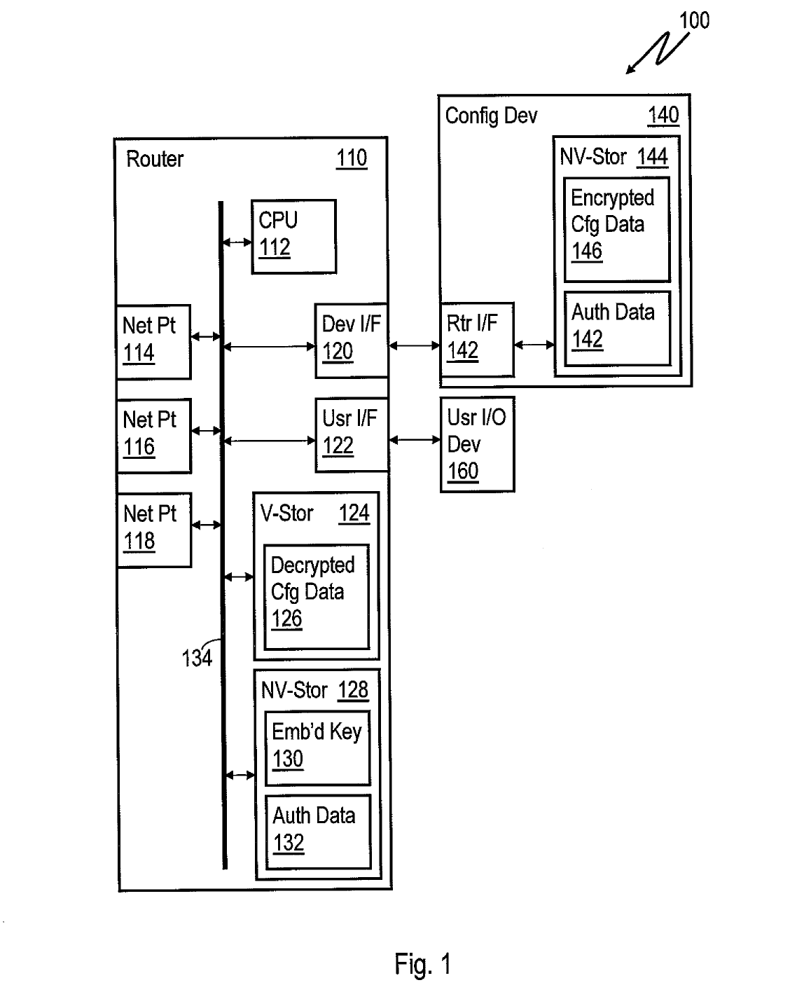

FIG. 1 shows a network routing system, constructed in accordance with at least some illustrative embodiments;

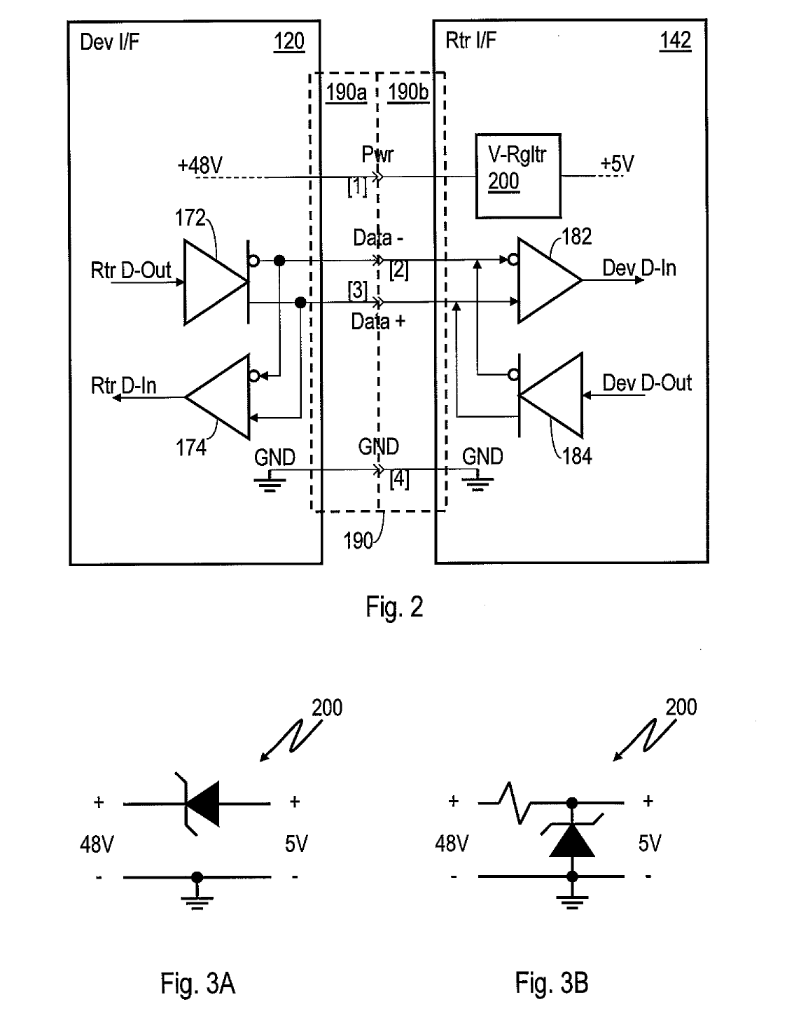

FIG. 2 shows details of the device and router interfaces of FIG. 1, constructed in accordance with at least some illustrative embodiments; and

FIGS. 3A and 3B show examples of a regulator circuit, usable as part of the router interface of FIGS. 1 and 2 and constructed in accordance with at least some illustrative embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Additionally, the term “system” refers to a collection of two or more hardware and/or software components, and may be used to refer to an electronic device, such as a computer, a network router, a portion of a computer or a network router, a combination of computers and/or network routers, etc.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

Routers are sometimes used as transfer points between secured and unsecured networks. When so utilized, the routers may be configured to protect information originating from, or destined to, a secure network and/or device. Such protection may include encryption of the data prior to transmission across an unsecured network (e.g., IPSec, RSA Public/Private Key Encryption, and Virtual Private Networks) as well as secure and/or encrypted authentication of a router on one end of the transaction by the router at the other end of the transaction (e.g., digital signatures). Because the configuration of these routers is a key element to ensuring data security, it is desirable to secure and control access to the configuration data of such routers.

FIG. 1 shows a network routing system 100 that utilizes a detachable configuration device to store and safeguard the configuration information of router 110, in accordance with at least some illustrative embodiments. Router 110 includes central processing unit (CPU) 112, network ports (Net Pts) 114-118, device interface (Dev I/F) 120, user interface (Usr I/F) 122, volatile storage (V-Stor) 124, and non-volatile storage (NV-Stor) 128, each of which couple to a common bus 134. CPU 112 controls the routing of data between network ports 114-118, based on decrypted configuration data (Decrypted Cfg Data) 126 stored within volatile storage 124. The configuration data is stored in encrypted form within configuration device (Config Dev) 140, which detachably couples to router 110 via device interface 120. Configuration device 140 includes router interface (Rtr I/F) 142 and non-volatile storage 144, each coupled to the other. Non-volatile storage 144 stores encrypted configuration data (Encrypted Cfg Data) 146, which is retrieved by CPU 112 of router 110 while configuration device 140 is coupled to device interface 120. CPU 112 uses embedded key (Emb'd Key) 130, stored within non-volatile storage 128, to decrypt the encrypted configuration data 146 to produce decrypted configuration data 126.

The configuration data 126 stored within configuration device 140 controls how and where data is routed. In at least some illustrative embodiments the configuration data includes a list of rules that govern the types of packets that are allowed to be transmitted from the source to the destination, a list of allowable destination addresses a network address space of the destination LAN, and a list of encryption/decryption keys, each key corresponding to an address of the allowable destination addresses. Each of the encryption/decryption keys may be used to encrypt and/or decrypt routed data, or may be used to encrypt messages used to exchange session keys, which are in turn used to encrypt and/or decrypt routed data.

Access to the embedded key 130, and thus to the configuration information required to operate the network routing system 100, may be controlled through the use of user-provided authentication information. In at least some illustrative embodiments, the authentication information is provided by a user operating user input/output device (Usr I/O Dev) 160, which is coupled to user interface 122. The input provided by the user may be in the form of a password, or in the form of biometric information (e.g., scanned fingerprint or retina data). The authentication information may then be compared to stored and/or encrypted reference copies of the authentication information, which may be stored either locally within the router 110 in non-volatile storage 128 (Auth Data 132), or in non-volatile storage 144 within configuration device 140 (Auth Data 142).

In addition to the software-based access controls described above, physical controls may also be used to protect the configuration data from unauthorized use, access, or malicious modification. In at least some illustrative embodiments, the configuration device couples to the router using a widely known and used connector form factor such as, for example, the Universal Serial Bus (USB) connector form factor promulgated by the USB Implementers Forum. In at least some illustrative embodiments of the invention, the pinout of the connector (including the order of the signals) that couples router 110 to configuration device 140 substantially matches the pinout defined for a USB connector (e.g., a USB Type A connector), but with a significantly higher voltage applied at the power pin than the voltage specified for a standard USB interface. Thus, even if a malicious user is able to bypass the encryption and authentication protection described above, when the user attempts to plug into the router 110 a standard USB-based memory device that stores unauthorized configuration data, the standard device will be damaged, destroyed, or otherwise rendered inoperable by the higher voltage on the power pin.

It should be noted that the use of a widely know and used form factor, such as the USB connector form factor, is in itself a security measure. Unless the malicious user has gained access to the electrical specification of the interface between the router 110 and the configuration device 140, the malicious user will be misdirected into believing that the configuration device is a standard, USB compliant memory device. If an unusual or little-known form-factor were used, the malicious user would realize that the electrical specification of the router/configuration device interface is needed, and thus would engage in efforts to obtain the information. The misdirection created through the use of a known form factor increases the chances that the malicious user will engage in an unsuccessful attempt at changing the configuration of the router, increasing the chances that said failed attempt will be detected and the malicious user identified.

FIG. 2 shows a more detailed diagram of the device interface 120 and router interface 142 of FIG. 1, constructed in accordance with at least some illustrative embodiments. Device interface 120 and router interface 142 couple to each other via connector 190 (e.g., a USB Type A connector), which includes two halves, one mechanically mounted to router 110 and electrically coupled to device interface 120 (connector half 190a) and the other mechanically mounted to configuration device 140 and electrically coupled to router interface 142 (connector half 190b). In at least some illustrative embodiments, pins [1] and [4] of connector 190 route power and ground respectively from device interface 120 to router interface 142, enabling the router 110 of FIG. 1 to provide power to operate configuration device 140. Continuing to refer to FIG. 2, pins [2] (Data−) and [3] (Data+) couple differential data driver 172 and differential receiver 174 of device interface 120 to differential driver 184 and differential receiver 182 of router interface 142. The differential data lines Data− and Data+ provide a bidirectional, half-duplex data path between the device interface 110 and router interface 142.

In at least some illustrative embodiments, the device interface 120 provides power on pin [1] that is at a voltage substantially higher than is needed to operate the components of configuration device 140. For example, the voltage level on pin [1] may be set to a voltage in the range of +24V to +60V, which is well outside the operating range of most +5V digital logic components. Thus, conventional devices, such as USB memory sticks, are rendered electrically incompatible with the router 110, despite having connectors that are mechanically compatible with those of the router 110. Router interface 142 renders configuration device 140 electrically compatible with router 110 by including a voltage regulator (V-Rgltr) 200, which accepts the higher voltage and regulates it down to the required voltage. For example, in the illustrative embodiment of FIG. 2 a +48 volt supply provided through device interface 120 is regulated down to +5 volts. Such regulators may easily be added to an existing conventional device (e.g., a USB memory stick), allowing the modified device to be used as the configuration device 140. FIG. 3A shows an example of a regulator circuit 200 that uses a single Zener diode 204 in series with the supply voltage provided through device interface 120. FIG. 3B shows another example of a regulator circuit 200 that uses a resistor 202 coupled to a Zener diode 204, and thus provides the supply voltage required to operate configuration device 140. Such regulator circuits are well known in the art, and all such regulator circuits are within the scope of the present disclosure.

The use of a voltage higher than that required by a standard device utilizing a standard interface serves to render the device inoperative when power provided through device interface 120 is applied to the device. Because the standard device is designed to operate at a much lower voltage, the device may be destroyed or damaged when the higher voltage is applied, or may enter a shutdown or protection mode wherein the device isolates itself from the high voltage applied. Nonetheless, in each of the described case the standard device is incompatible and unable to interact with the router 110, thus rendering the standard device inoperative and unsuitable for use as a configuration device. As a result, the configuration of the router 110 cannot be changed or accessed using a standard device.

Further, as an additional safeguard, the router 110 may be designed to disable itself or shutdown when an attempt is made to use an incompatible configuration device 140. For example, in at least some illustrative embodiments the use of an incompatible device causes the current flowing to the device to be high (i.e., an overcurrent condition), due to the breakdown of the device when connected to the higher than normal voltage. A fuse is coupled in series with the device (e.g., within device interface 120), which opens in the presence of the overcurrent condition. The blown fuse prevents any other device, compatible or incompatible, from functioning after an attempt is made to use an incompatible device. The router 110 must be serviced (i.e., the fuse replaced and the device rebooted and/or reconfigured) by authorized personnel before the router 110 can be returned to operation, bringing attention to the attempted unauthorized reconfiguration. In other illustrative embodiments, logic within the router 110 detects the overcurrent condition caused by the attempted use of an incompatible device, causing the router 110 to enter a lockdown mode. Additionally, in at least some illustrative embodiments an alarm is generated and logged at the router and/or an external monitoring system, indicative of the failed attempt. Other responses to the detection of the attempted use of an incompatible device will become apparent to those of ordinary skill in the art, and all such responses are within the scope of the present disclosure.

As described above, other devices, such as conventional USB memory sticks, which use the same connector form factor and signal ordering might appear to an uninformed malicious user to be compatible with the device interface 110. A malicious user attempting to couple such a USB memory stick to device interface 110 would fail in his attempt to configure the router with the memory stick, and the memory stick would be rendered unusable for future attempts. In at least some other illustrative embodiments, a voltage regulator 200 is used that requires a minimum operating voltage above that required to operate a standard USB memory stick (e.g., +30V). In such an embodiment, the configuration device 140 cannot be operated or its contents accessed using a standard USB interface. This provides an additional layer of security by making the configuration device 140 accessible only by the router 110 and a configuration server (not shown) designed to program the configuration device 140.

In yet other illustrative embodiments, the supply voltage provided by router 110 on pin [1] of connector 190 (FIGS. 1 and 2) is initially set at +5 volts, but transitioned to +48 volts when the configuration device is accessed. In this manner, if a malicious user takes static measurements of the voltages on the pins on the router side of connector 190 (connector half 190a), the pins will appear to operate in accordance with a standard interface (e.g., a USB interface), again misdirecting the malicious user. An attempt to use a conventional device (e.g., a USB memory stick) again results in the device being rendered unusable, once the router logic attempts to access the device, due to the increased voltage (e.g., +48V) applied when the device is accessed.

The above disclosure is meant to be illustrative of the principles and various embodiments of the present invention. Numerous variations and modifications will become apparent to those skilled in the art once the above disclosure is fully appreciated. For example although the embodiments described utilize USB devices, connectors and interfaces, any number of devices, connectors and interfaces may be used (e.g., CompactFlash, Secure Digital (SD) and Smart Card), and the scope of the present disclosure is not limited to USB devices, connectors and interfaces. It is intended that the following claims be interpreted to embrace all such variations and modifications.

What is claimed is:

1. A system, comprising:
a network router;
a configuration device comprising configuration data used to configure the network router; and
a connector capable of detachably coupling the configuration device to the network router and further capable of detachably coupling a second device to the network router, the connector routes electrical power provided by the network router to a coupled device;
wherein the electrical power is set to a voltage level usable to operate the configuration device, while capable of rendering the second device inoperative.

2. The system of claim 1, wherein the configuration device provides signals to each pin of the connector in the same order as signals provided by the second device.

3. The system of claim 1, wherein the connector comprises a Universal Serial Bus connector, and wherein the voltage level is above +5 volts.

4. The system of claim 1, wherein the voltage level is above +5 volts, and wherein the second device is rendered inoperative above +5 volts.

5. The system of claim 1, wherein the configuration device comprises a voltage regulator that regulates down the voltage level such that said power can be used to operate the configuration device.

6. The system of claim 5, wherein the voltage regulator requires a minimum voltage level to operate the configuration device, the minimum voltage level being greater than a maximum voltage usable to operate the second device.

7. The system of claim 1,
wherein the power provided by the network router is applied to the second device at or below a maximum voltage, usable to operate the second device, when the second device is coupled to the network router; and
wherein the power is applied to the second device at the voltage level when the second device is accessed by the network router.

8. The system of claim 1, wherein the router is disabled if the second device is coupled to the router.

9. The system of claim 1, wherein the router signals and logs an alarm condition if the second device is coupled to the router.

10. The system of claim 1, wherein the router signals an alarm condition to an external monitoring system for logging by said external system if the second device is coupled to the router.

11. A system, comprising:
a network router;
means for storing data to configure the network router;
means for detachably coupling either the means for storing or an electrically incompatible device to the network router, and for routing electrical power from the network router to the means for storing and the electrically incompatible device; and
means for generating a voltage that is usable to operate the means for storing while rendering the electrically incompatible device inoperative.

12. The system of claim 11, wherein the means for storing data provides signals to each pin of the means for detachably coupling in the same order as signals provided by the electrically incompatible device.

13. The system of claim 11, wherein the means for configuring comprises a means for regulating the voltage for operating the means for storing.

14. The system of claim 13, wherein the means for regulating requires a minimum voltage level to operate the means for storing, the minimum voltage level being greater than a maximum voltage usable to operate the electrically incompatible device.

15. The system of claim 11,
wherein the power provided by the network router is applied to the electrically incompatible device at or below a maximum voltage, usable to operate the electrically incompatible device, when the electrically incompatible device is coupled to the network router; and
wherein the power is applied to the electrically incompatible device at the first voltage level when the electrically incompatible device is accessed by the network router.

16. The system of claim 11, wherein the router is disabled if the electrically incompatible device is coupled to the router.

17. The system of claim 11, wherein the router signals and logs an alarm condition if the electrically incompatible device is coupled to the router.

18. The system of claim 11, wherein the router signals an alarm condition to an external monitoring system for logging by said external system if the electrically incompatible device is coupled to the router.

19. A system, comprising:
a network router; and
a connector capable of detachably coupling each of a plurality of devices to the network router, the connector further capable of routing electrical power provided by the network router to a coupled device;
wherein the electrical power is set to a voltage level usable to operate an electrically compatible device of the plurality of devices, while capable of rendering an electrically incompatible device of the plurality of devices inoperative.

20. The system of claim 19, wherein the electrically compatible device provides signals to each pin of the connector in the same order as the electrically incompatible device.

21. The system of claim 19, wherein the electrically compatible device is a storage device comprising data used to configure the network router.

22. The system of claim 19, wherein the connector comprises a Universal Serial Bus connector, and wherein the voltage level is above +5 volts.

23. The system of claim 19, wherein the voltage level is above +5 volts, and wherein the electrically incompatible device is rendered inoperative above +5 volts.

24. The system of claim 19, wherein the electrically compatible device comprises a voltage regulator that regulates down the voltage level such that said power can be used to operate the electrically compatible device.

25. The system of claim 24, wherein the voltage regulator requires a minimum voltage level to operate the electrically compatible device, the minimum voltage level greater than a maximum voltage usable to operate the electrically incompatible device.

26. The system of claim 19,
wherein the power provided by the network router is applied to the coupled device at or below a maximum voltage, usable to operate the electrically incompatible device, when the coupled device is coupled to the network router; and
wherein the power is applied to the coupled device at the voltage level when the electrically incompatible device is accessed by the network router.
